(19) United States
(12) Patent Application Publication
(10) Pub. No.: US 2017/0169037 A1
(43) Pub. Date: Jun. 15, 2017

(54) ORGANIZATION AND DISCOVERY OF COMMUNICATION BASED ON CROWD SOURCING

(71) Applicant: MICROSOFT TECHNOLOGY LICENSING, LLC, Redmond, WA (US)

(72) Inventors: Shan Qu, Redmond, WA (US); Tom Laird-McConnell, Redmond, WA (US); Naresh Sundaram, Redmond, WA (US); Amit Gupta, Redmond, WA (US); Nithya Ramkumar, Redmond, WA (US); Johannes Gehrke, Bellevue, WA (US)

(21) Appl. No.: 14/965,970

(22) Filed: Dec. 11, 2015

(51) Int. Cl. G06F 17/30; G06F 3/0484

(52) U.S. Cl. CPC G06F 17/3064; G06F 17/30705; G06F 3/0484

(57) ABSTRACT

Organization and discovery of a communication is provided based on crowd sourcing. A communication application initiates operations to categorize a communication in response to a detected input to categorize the communication with a hashtag. Hashtag suggestions based on the input are generated and presented. The communication is categorized based on the hashtag selected from one of the hashtag suggestions or a new hashtag. The hashtag is presented in association with the communication.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications facilitate communications. Poorly organized communications by a communication application complicate discovery of a communication.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to organization and discovery of a communication based on crowd sourcing. In some examples, a communication application may detect an input to categorize a communication with a hashtag. In response, hashtag suggestions may be presented based on the input. The communication may be categorized based on a selected hashtag from the hashtag suggestions or a new hashtag. Next, the hashtag may be presented in association with the communication.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of categorizing a communication with a hashtag, according to embodiments;

FIG. 2 is a display diagram illustrating an example of providing hash tag suggestions in response to an intent to categorize a communication, according to embodiments;

FIG. 3 is a display diagram illustrating an example of focusing hash tag suggestions based on continued input to categorize a communication, according to embodiments;

FIG. 4 is a display diagram illustrating an example of grouping communications based on a common hash tag, according to embodiments;

FIG. 5 is a simplified networked environment, where a system according to embodiments may be implemented;

FIG. 6 is a block diagram of an example computing device, which may be used to provide organization and discovery of a communication based on crowd sourcing, according to embodiments; and

FIG. 7 is a logic flow diagram illustrating a process for providing organization and discovery of a communication based on crowd sourcing, according to embodiments.

### DETAILED DESCRIPTION

As briefly described above, organization and discover of a communication may be provided based on crowd sourcing by a communication application. The communication application may include an email processing application, a messaging application, a document processing application, a spreadsheet processing application, a presentation application, and/or a conferencing application, among others. In an example scenario, the communication application may detect an input to categorize the communication with a hashtag. A communication may include an email, a message, and/or a video/audio conference, among others. A hashtag may include one or more words used to categorize the communication. The hashtag may include a subject, a topic, an interest, and/or a title, among other things associated with the communication.

Hashtag suggestions based on the input may be presented in response to the input. The hashtag suggestions may be generated from previously used hashtags based on frequency of usage and/or recentness of usage, among other criteria. Next, the communication may be categorized based on a hashtag. The hashtag may include a selected hashtag from the hashtag suggestions or a new hashtag. The hashtag may be presented in association with the communication.

In the following detailed description, references are made to the accompanying drawings that form a part hereof, and in which are shown by way of illustrations, specific embodiments, or examples. These aspects may be combined, other aspects my be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide organization and discovery of a communication based on crowd sourcing. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operation system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience a visual display associated with an application or service through which a user interacts with the application or service. A user action refers to an interaction between a user and a user experience of art application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

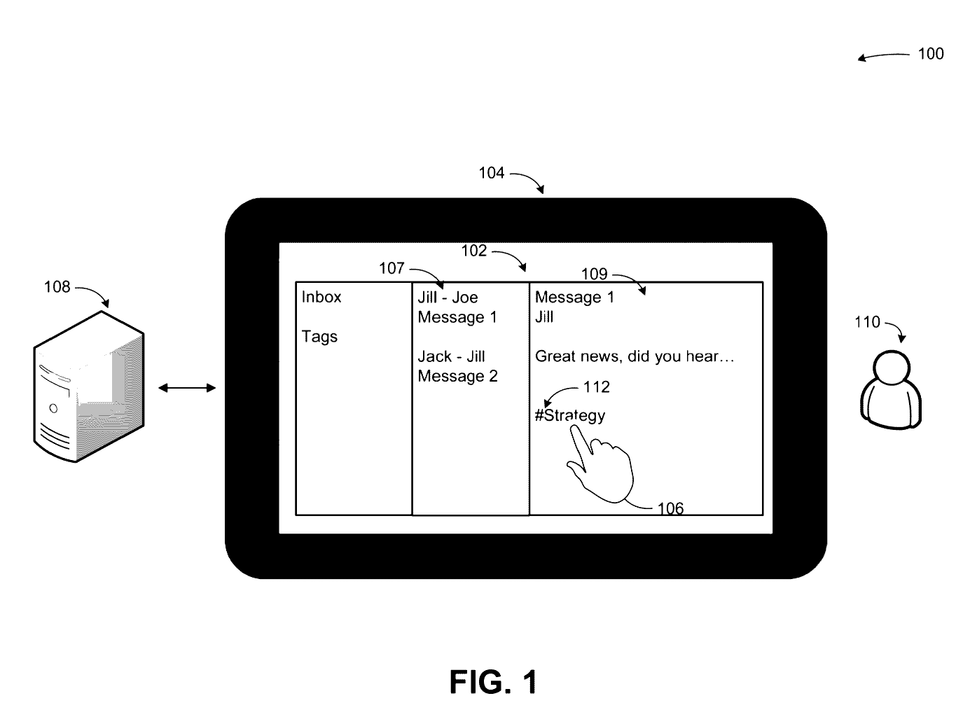

FIG. 1 is a conceptual diagram illustrating an example of categorizing a communication with a hashtag, according to embodiments.

In a diagram 100, a computing device 104 may execute a communication application 102. Examples of the communication application 102 may include an email processing application, a messaging application, a document processing application, a spreadsheet processing application, a presentation application, and/or a conferencing application, among others. The computing device 104 may include a tablet device, a laptop computer, a desktop computer, and a smart phone, among others. The computing device 104 may include a special purpose computing device configured to provide communications management through a display component configured to display communications, a communication component configured to transmit communications, and/or a storage component configured to store communications, among other components.

The computing device 104 may display the communication application 102 to an organizer 110. The organizer may be a participant in communications with other participants. The organizer 110 may be allowed to interact with the communication application 102 through input device or touch enabled display component of the computing device 104. The computing device 104 may also include a display device such as the touch enabled display component, and a monitor, among others to provide the communication application 102 to the organizer 110.

A rendering module of the communication application 102 may present communication summaries 107 of communications between the organizer 110 and other participants. The rendering module may also display a communication 109 associated with one of the communication summaries. The communication 109 may include an email, a message, a video conference, and/or an audio conference, among others.

An input to categorize the communication 109 with a hashtag 112 may be detected by the rendering module. In response to the input, hashtag suggestions based on the input may be presented. An organization module of the communication application 102 may categorize the communication 109 based on the hashtag 112. The hashtag may include a selected hashtag by the organizer 110 from the hashtag suggestions or a new hashtag created by the organizer 110. The hashtag 112 may be provided to the rendering module for a presentation in association with the communication 109.

The communication 109 may be stored and managed locally within the computing device 104. Alternatively, the communication 109 may be retrieved from a server 108. The server 108 may include a content server and/or a communication server, among others. The server 108 may also host and manage communications. An example of the server 108 may include an email server that provides communications to be presented by the communication application 102. Additionally, the computing device 104 may communicate with the server 108 through a network. The network may provide wired or wireless communications between nodes such as the computing device 104, or the server 108, among others.

Alternatively, the server 108 may provide the communication application 102. The computing device 104 may display a client user interface of the communication application 102. The server 108 may execute operations associated with organization of the communication 109 with a hashtag 112.

The organizer 110 may interact with the communication application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 104, the communication application 102, embodiments are not limited to these components or system configurations and can be implemented with other system configuration employing fewer or additional components.

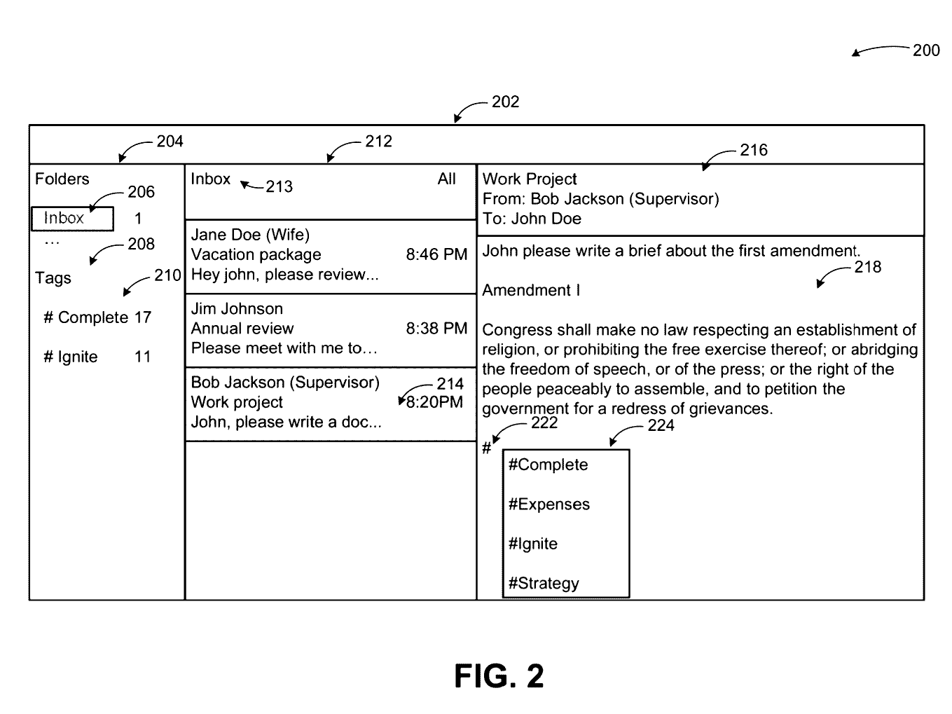

FIG. 2 is a display diagram illustrating an example of providing hash tag suggestions in response to an intent to categorize a communication, according to embodiments.

In a diagram 200, a communication application 202 may provide elements to organize a communication 216 with a hashtag. An example of the communication application 202 may include an email processing application. An example of a communication may include an email. An example of a hashtag may include a label or a description used to categorize the communication 216.

A rendering module of the communication application 202 may display a navigation user interface 204 to present navigation elements to interact with communications and hashtags that categorize the communications. A navigation element 206 may include operations to provide summaries of communications in a summaries user interface 212. Furthermore, the navigation user interface 204 may include hashtag navigation section 208. The hashtag navigation section 208 may include a hashtag navigation element 210 with operations to display communication summaries. The communication summaries may refer to communications that are categorized with a hashtag associated with the hashtag navigation element 210. The hashtag navigation element 210 may include an actionable hashtag and a counter that reflects the number of the communications organized by the hashtag.

The summaries user interface 212 may include summaries of the communications. A summary 214 of the communication 216 may include information such as a sender, a subject, a time received (and/or sent), and/or a summary of the content, among others. The summary 214 may also display a hashtag used to categorize the communication 216. The hashtag displayed by the summary 214 may be actionable. In response to an action on the hashtag displayed within the summary 214, summaries of the communications that are categorized with the hashtag may be displayed in the summaries user interface 212. The rendering module of the communication application 202 may also display the communication 216 in response to an action detected on the summary 214 (associated with the communication 216). The communication 216 may include information such as a subject, a sender, a participant (such as the receiver and/or the organizer), a time received (and/or sent), and/or a content 218 of the communication 216.

The rendering engine of the communication application 202 may also detect an input 222 to categorize the communication 216 with a hashtag. The input 222 may start with a hashtag character (such as a hash character, and/or a number sign, among others). The input 222 may also start with (or the hashtag character may include) another specialized character, an image, and/or graphic, among others to indicate start of a hashtag. In response to the input 222, a list of hashtag suggestions 224 may be generated by an organization module of the communication application 202. The hashtag suggestions 224 may be generated based on previous hashtags used by an organizer to categorize the communication 216 or other communications. The previous hashtags may be selected based on a frequency of usage or a recentness of usage. The previous hashtags may also be selected based on trending data associated with an organizer or stakeholders associated with or important to the organizer. In an example scenario, the previous hashtags may be ordered based on a frequency of usage from a high frequency of usage to a low frequency of usage. The ordered previous hashtags may be provided as the hashtag suggestions 224. Alternatively, the previous hashtags may be ordered based on a recentness of usage. The previous hashtags may be ordered from a recent usage to a distant usage. The ordered previous hashtags may be provided as the hashtag suggestions 224.

The organization module may retrieve previous hashtags from a historical source that manages relationships between a communication, an organizer, and/or other communications, among others through previous hashtags. The previous hashtags may also be retrieved from a cache (in a local memory/storage, or in a remote memory/storage) used to store recently used hashtags.

The organization module may also analyze the content 218 of the communication 216. The content 218 may be analyzed to identify key words associated with the communication 216. The content 218 may be parsed to detect key words such as a topic, a subject, a category, an interest, and/or a role, among other labels that define a relationship between entities. The key words may be provided as the hashtag suggestions 224.

The organization module of the communication application 202 may also analyze context information associated with the communication 216 to identify the hashtag suggestions 224. For example, context information such as a location associated with the communication 216, a sender of the communication 216, and/or an organizer of the communication 216, among others may be matched to related hashtags that are a subset of the previous hashtags with attributes in common with the context information. The related hashtags may be provided as the hashtag suggestions 224. In an example scenario, a location of the sender such as a city may matched with a previous hashtag used to categorize the city. The previous hashtag may be provided as a hashtag suggestion.

The organization module may also query sources (local or external) to identify keys words associated with the content information parsed from the content. Context information such as a relationship between entities (participants, organizations, communications) may be used to locate key words at the sources (such as a personnel provider, and/or a social networking provider, among others). The key words may be classified as the hashtag suggestions 224.

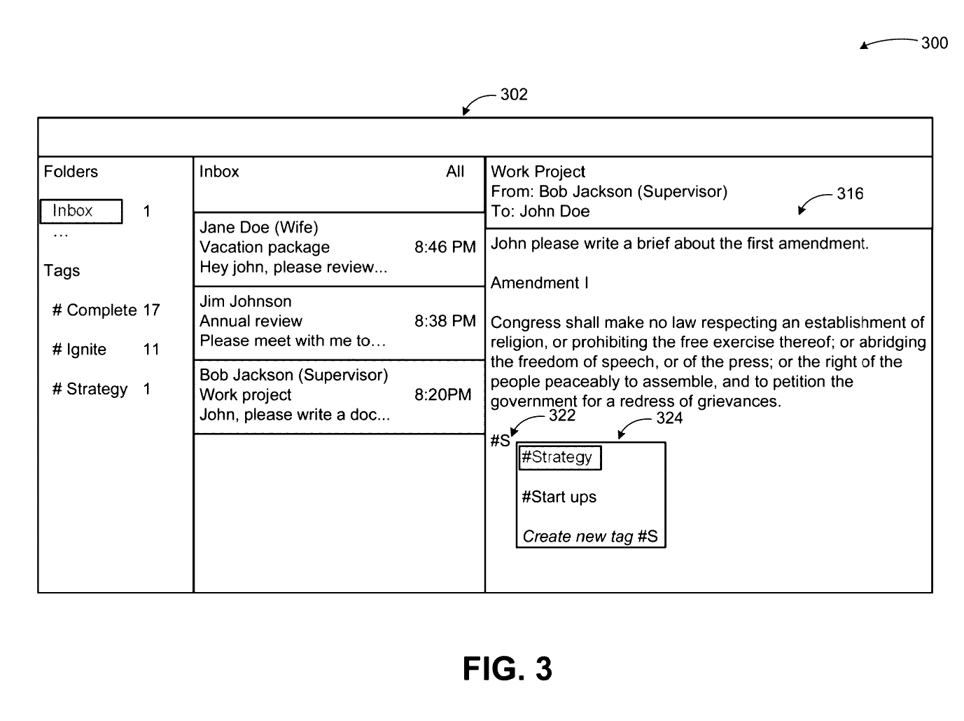

FIG. 3 is a display diagram illustrating an example of focusing hash tag suggestions based on continued input to categorize a communication, according to embodiments.

In a diagram 300, a communication application 302 may focus hashtag suggestions 224 based on a continued input 322 by an organizer of a communication 316. The organizer may wish to categorize the communication with a hashtag and provide an input that starts with a hashtag character to initiate a process to categorize the communication. In response, an organization module of the communication application 302 may generate a list of hashtag suggestions 224 to present to the organizer a selection of options for a hashtag to categorize the communication 316.

A continued input 322 may be detected by a rendering module of the communication application 302 to focus the hashtag suggestions 324. The continued input 322 may include another character such as a letter to filter the hashtag suggestions 224 based on the continued input 322. For example, a letter may be detected as a continued input 322 to categorize the communication 316 with a hashtag that starts with the letter “S”. In response, the organization module may filter the hashtag suggestions 224 to provide the hashtag suggestions 324 that match the continued input provided by the organizer.

The organization module of the communication application 302 may categorize the communication with a hashtag selected from the hashtag suggestions 324. As a result, a new hashtag navigation element associated with the hashtag may be created to present the new relationship between the hashtag and the communication 316. A counter with a number of “1” may be placed in proximity to the hashtag navigation element to indicate the communication 316 as categorized with the hashtag. Alternatively, if a hashtag navigation element associated with the hashtag of the communication 316 already exists, a counter of associated communications in proximity to the hashtag navigation element may be incremented.

An organizer of the communication 316 may also be provided with user interface elements to create a new hashtag based on the continued input 322. User interface elements may be provided to capture additional input and categorize the communication 316 with the new hashtag.

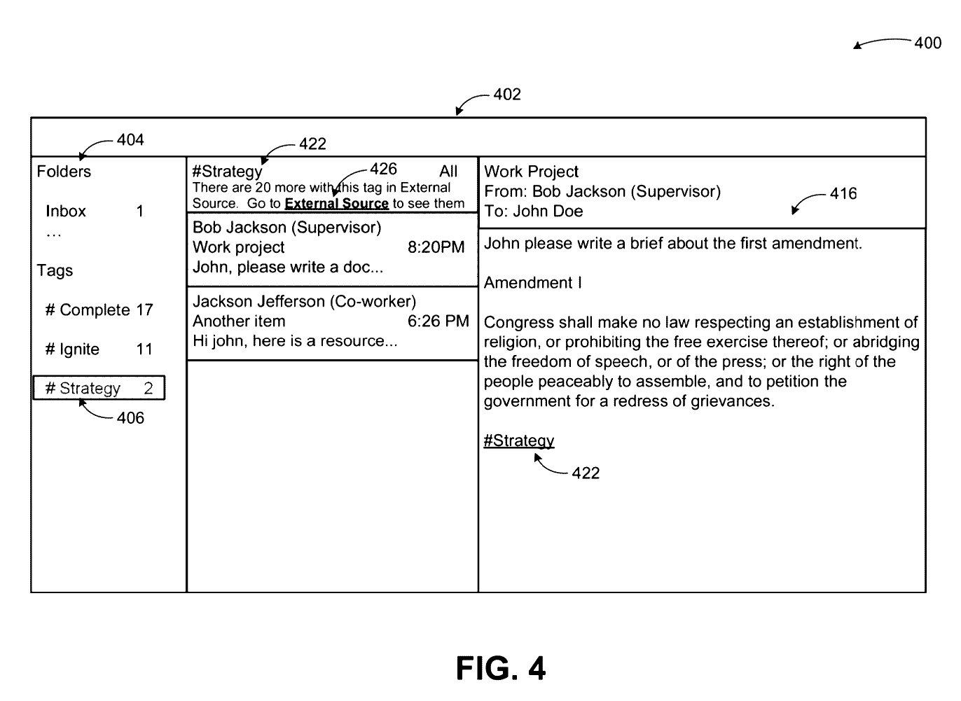

FIG. 4 is a display diagram illustrating an example of grouping communications based on a common hash tag, according to embodiments.

In a diagram 400, a communication application 402 may detect an action on a hashtag 422 used to categorize a communication 416. In response to the action on the hashtag 422, a rendering engine of the communication application 402 may highlight a hashtag navigation element 406 on a navigation user interface of the communication application. The rendering module may also present communication summaries of the communication 416 and other communications categorized by the hashtag 422 in a summaries user interface. Alternatively, the hashtag navigation element 406 may provide operations to display communication summaries of the communications associated with the hashtag 422 within a summaries user interface of the communication application 402.

The summaries user interface may also display the hashtag 422 as a label. The hashtag 422 may alternatively be displayed within each summary to indicate a categorization of the associated communication with the hashtag 422. Additionally, an organization module of the communication application 402 may query an external source with the hashtag 422 to identify external communications categorized with the hashtag. A location 426 of the external source and a counter referring to the number of external communication categorized with the hashtag may also be displayed in proximity to the communication summaries. The location 426 of the external source may include a link to access the external communications categorized with the hashtag 422.

As discussed above, the application may be employed to perform operations to automate organization and discovery of a communication based on crowd sourcing. An increased user efficiency with the communication application 102 may occur as a result of categorizing a communication with a hashtag and locating other communications similarly categorized through the hashtag. Additionally, presenting a hashtag in associated with a communication in navigation and viewing user interfaces of the communication application 102 may reduce processor load, increase processing speed, conserve memory, and reduce network bandwidth usage.

Embodiments, as described herein, address a need that arises from a lack of efficiency between the organizer 110 interacting with the communication application 102 of the computing device 104. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Organization and discovery of a communication based on crowd sourcing may be implemented in configurations employing fewer or additional components in applications and user interfaces. Furthermore, the example schema and components shown in FIG. 1 through 4 and their subcomponents may be implemented in a similar manner with other values using the principles described herein.

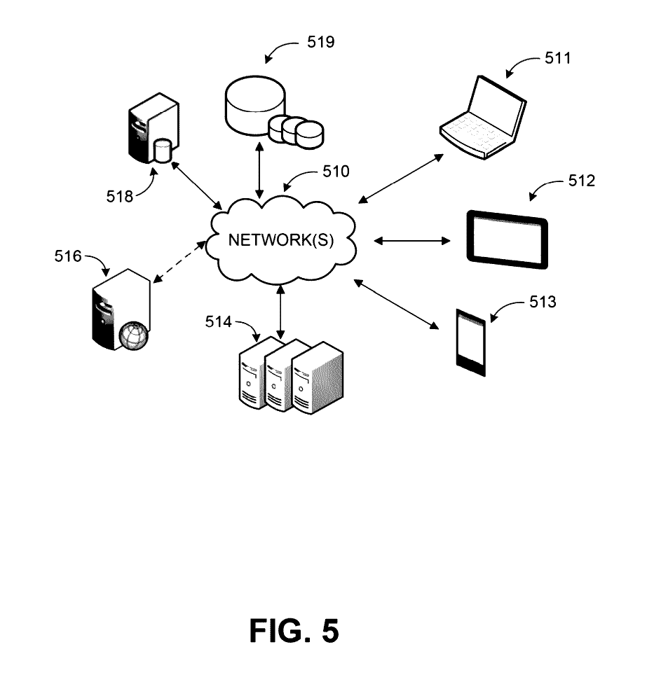

FIG. 5 is an example networked environment, where embodiments may be implemented. A communication application configured to provide organization and discovery of a communication based on crowd sourcing may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed b servers 514, or on individual server 516. A communication application may detect an input to categorize a communication with a hashtag. In response, hashtag suggestions based on the input may be presented. The communication may be categorized based on a selected hashtag from the hashtag suggestions or a new hashtag. The hashtag may be presented in association with the communication. The communication application may store data associated with the hashtag and the communication in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide organization and discover of a communication based on crowd sourcing. Furthermore, the networked environments discussed in FIG. 5 are for illustration purposes only. Embodiments are not limited to the example applications, modules, or processes.

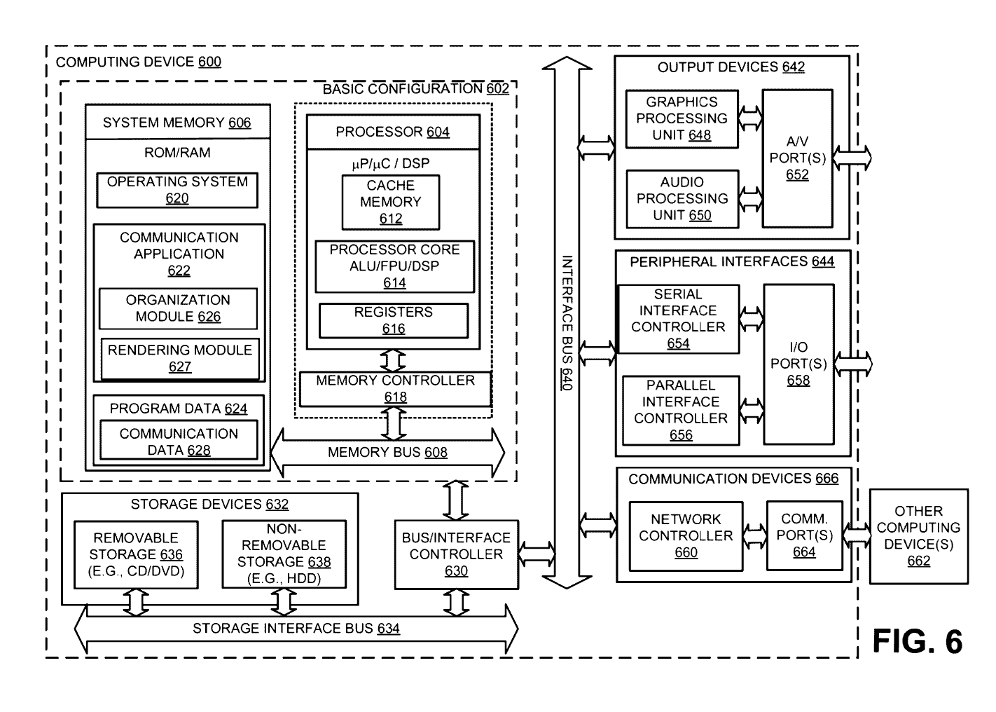

FIG. 6 is a block diagram of an example computing device, which may be used to provide organization and discovery of a communication based on crowd sourcing, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a communication application 622, and a program data 624. The communication application 622 may include components such as an organization module 626 and a rendering module 627. The organization module 626 and the rendering module 627 may execute the processes associated with the communication application 622. The rendering module 627 may detect an input to categorize a communication with a hashtag. Next, hashtag suggestions based on the input may be presented. The organization module 626 may categorize the communication based on a selected hashtag from the hashtag suggestions or a new hashtag. Next, the hashtag may be provided to the rendering module 627 to present in association with the communication.

Components of the communication application 622 (such as a user interface) may also be displayed on a display device associated with the computing device 600. An example of the display device may include a hardware screen that may be communicatively coupled to the computing device 600. The display device may include a touch based device that detects gestures such as a touch action. The display device may also provide feedback in response to detected gestures (or any other form of input) by transforming a user interface of the communication application 622, displayed by the touch based device. The program data 624 may also include, among other data, communication data 628, or the like, as described herein. The communication data 628 may include a hashtag, and/or a communication, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide organization and discovery of a communication based on crowd sourcing. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

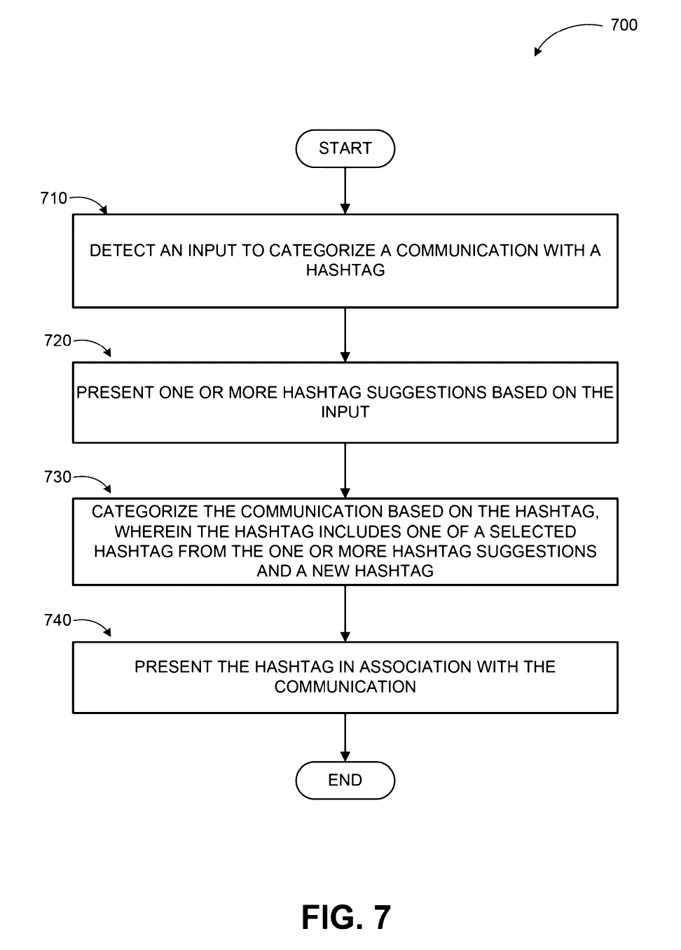

FIG. 7 is a logic flow diagram illustrating a process for providing organization and discovery of a communication based on crowd sourcing, according to embodiments. Process 700 may be implemented on a computing device, such as the computing device 600 or another system.

Process 700 begins with operation 710, where a communication application may detect an input to categorize a communication with a hashtag. The hashtag may include a label or a description to provide a relationship between the communication and another entity (such as another communication, and/or a participant, among others). Hashtag suggestions based on the input may be presented at operation 720. The hashtag suggestions may include previous hashtags that are ordered based on a frequency of usage, and/or a recentness of usage, among others.

At operation 730, the communication may be categorized based on the hashtag. The hashtag may include a selected hashtag from the hashtag suggestions or a new hashtag. The new hashtag may be captured from an input provided by an organizer of the communication. At operation 740, the hashtag may be presented in association with the communication.

The operations included in process 700 are for illustration purposes. Organization and discovery of a communication based on crowd sourcing may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a computing device for providing organization and discovery of a communication based on crowd sourcing is described. The computing device includes a display device, a memory configured to store instructions associated with a communication application, and one or more processors couple to the memory and the display device. The one or more processors execute the communication application in conjunction with the instructions stored in the memory. The communication application includes a rendering module and an organization module. The rendering module is configured to detect an input to categorize the communication with a hashtag and present, on the display device, one or more hashtag suggestions based on the input. The organization module is configured to categorize the communication based on the hashtag, where the hashtag includes one of a selected hashtag from the one or more hashtag suggestions and a new hashtag and provide the hashtag for a presentation in association with the communication.

In other examples, the organization module is further configured to receive the input from the rendering module and identify the input as starting with a hashtag character. The organization module is further configured to order previous hashtags based on a recentness of usage, provide the ordered previous hashtags to the rendering module to present as the one or more hashtag suggestions, and retrieve the previous hashtags from a historical hashtag source that manages one or more associations between one or more of: the communication, an organizer of the communication, one or more other communications through the previous hashtags. The organization module is further configured to order previous hashtags based on a frequency of usage, provide the ordered previous hashtags to the rendering module to present as the one or more hashtag suggestions, and retrieve the previous hashtags from a cache used to store recently used hashtags.

In further examples, the organization module is further configured to analyze a content of the communication to identify one or more key words associated with the communication, provide the one or more key words to the rendering module to present as the one or more hashtag suggestions, and parse the content of the communication to detect the one or more key words, where the content is parsed based on one or more of: a topic, a subject, a category, an interest, and a role detected in the content.

In other examples, the organization module is further configured to analyze a content of the communication to identify context information associated with the communication, match the context information to related hashtags, and provide the related hashtags as the one or more hashtag suggestions. The organization module is further configured to identify the context information as a location, where the location includes one or more of: an origin location of the communication, a physical location of a sender of the communication, and another physical location of an organizer of the communication. The organization module is further configured to query one or more sources to identify one or more key words associated with the context information, where the one or more sources include one or more of a local source and an external source and classify the one or more key words as the related hashtags.

In some examples, a method executed on a computing device for providing organization and discovery of a communication based on crowd sourcing is described. The method includes detecting an input to categorize the communication with hashtag, where the input starts with a hashtag character, presenting one or more hashtag suggestions based on the input, categorizing the communication based on the hashtag, where the hashtag includes one of a selected hashtag from the one or more hashtag suggestions and a new hashtag, and presenting the hashtag in association with the communication.

In other examples, the method further includes detecting an action on the hashtag displayed with the communication and identifying one or more other communications categorized with the hashtag. The method further includes presenting a hashtag navigation element on a navigation user interface, where the hashtag navigation element includes operations to display one or more communication summaries of the communication and the one or more other communications categorized with the hashtag and highlighting the hashtag navigation element. The method further includes presenting a hashtag navigation element on a navigation user interface, where the hashtag navigation element includes a counter that reflects a number of the communication and the one or more other communications categorized with the hashtag. The method further includes displaying one or more communication summaries on a summaries user interface, where the one or more communication summaries represent the communication and the one or more other communications categorized with the hashtag, querying an external source with the hashtag to identify one or more external communications categorized with the hashtag, and presenting, in proximity to the one or more communication summaries, a description of the external source and a link to the external source to access the one or more external communications.

In some examples, a computer-readable memory device with instructions stored thereon for providing organization and discovery of a communication based on crowd sourcing is described. The instructions include actions that are similar to the actions of the previously described method.

In some examples, a means for providing organization and discovery of a communication based on crowd sourcing is described. The means for providing organization and discovery of a communication based on crowd sourcing includes a means for detecting an input to categorize the communication with a hashtag, a means for presenting one or more hashtag suggestions based on the input, a means for categorizing the communication based on the hashtag, where the hashtag includes one of a selected hashtag from the one or more hashtag suggestions and a new hashtag, and a means for providing the hashtag for a presentation in association with the communication.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for providing organization and discovery of a communication based on crowd sourcing, the computing device comprising:
a display device;
a memory configured to store instructions associated with a communication application;
one or more processors coupled to the memory and the display device, the one or more processors executing the communication application in conjunction with the instructions stored in the memory, wherein the communication application includes:
a rendering module configured to:
detect an input to categorize the communication with a hashtag;
present, on the display device, one or more hashtag suggestions based on the input; and
an organization module configured to:
categorize the communication based on the hashtag, wherein the hashtag includes one of a selected hashtag from the one or more hashtag suggestions and a new hashtag; and
provide the hashtag for a presentation in association with the communication.

2. The computing device of claim 1, wherein the organization module is further configured to:
receive the input from the rendering module; and
identify the input as starting with a hashtag character.

3. The computing device of claim 2, wherein the organization module is further configured to:
order previous hashtags based on a recentness of usage; and
provide the ordered previous hashtags to the rendering module to present as the one or more hashtag suggestions.

4. The computing device of claim 3, wherein the organization module is further configured to:
retrieve the previous hashtags from a historical hashtag source that manages one or more associations between one or more of: the communication, an organizer of the communication, one or more other communications through the previous hashtags.

5. The computing device of claim 2, wherein the organization module is further configured to:
order previous hashtags based on a frequency of usage; and
provide the ordered previous hashtags to the rendering module to present as the one or more hashtag suggestions.

6. The computing device of claim 5, wherein the organization module is further configured to:
retrieve the previous hashtags from a cache used to store recently used hashtags.

7. The computing device of claim 1, wherein the organization module is further configured to:
analyze a content of the communication to identify one or more key words associated with the communication; and
provide the one or more key words to the rendering module to present as the one or more hashtag suggestions.

8. The computing device of claim 7, wherein the organization module is further configured to:
parse the content of the communication to detect the one or more key words, wherein the content is parsed based on one or more of: a topic, a subject, a category, an interest, and a role detected in the content.

9. The computing device of claim 1, wherein the organization module is further configured to:
analyze a content of the communication to identify context information associated with the communication;
match the context information to related hashtags; and
provide the related hashtags as the one or more hashtag suggestions.

10. The computing device of claim 9, wherein the organization module is further configured to:
identify the context information as a location, wherein the location includes one or more of: an origin location of the communication, a physical location of a sender of the communication, and another physical location of an organizer of the communication.

11. The computing device of claim 9, wherein the organization module is further configured to:
query one or more sources to identify one or more key words associated with the context information, wherein the one or more sources include one or more of a local source and an external source; and
classify the one or more key words as the related hashtags.

12. A method executed on a computing device for providing organization and discovery of a communication based on crowd sourcing, the method comprising:
detecting an input to categorize the communication with a hashtag, wherein the input starts with a hashtag character;
presenting one or more hashtag suggestions based on the input;
categorizing the communication based on the hashtag, wherein the hashtag includes one of a selected hashtag from the one or more hashtag suggestions and a new hashtag; and
presenting the hashtag in association with the communication.

13. The method of claim 12, further comprising:
detecting an action on the hashtag displayed with the communication; and
identifying one or more other communications categorized with the hashtag.

14. The method of claim 13, further comprising:
presenting a hashtag navigation element on a navigation user interface, wherein the hashtag navigation element includes operations to display one or more communication summaries of the communication and the one or more other communications categorized with the hashtag; and
highlighting the hashtag navigation element.

15. The method of claim 13, further comprising:
presenting a hashtag navigation element on a navigation user interface, wherein the hashtag navigation element includes a counter that reflects a number of the communication and the one or more other communications categorized with the hashtag.

16. The method of claim 13, further comprising:
displaying one or more communication summaries on a summaries user interface, wherein the one or more communication summaries represent the communication and the one or more other communications categorized with the hashtag.

17. The method of claim 16, further comprising:
querying an external source with the hashtag to identify one or more external communications categorized with the hashtag; and
presenting, in proximity to the one or more communication summaries, a description of the external source and a link to the external source to access the one or more external communications.

18. A computer-readable memory device with instructions stored thereon for providing organization and discovery of a communication based on crowd sourcing, the instructions comprising:
detecting an input to categorize the communication with a hashtag, wherein the input starts with a hashtag character;
presenting one or more hashtag suggestions based on the input;
categorizing the communication based on the hashtag, wherein the hashtag includes one of a selected hashtag from the one or more hashtag suggestions and a new hashtag; and
presenting the hashtag in association with the communication.

19. The computer-readable memory device of claim 18, wherein the instructions further comprise:
analyzing a content of the communication to identify context information associated with the communication;
matching the context information to related hashtags;
providing the related hashtags as the one or more hashtag suggestions; and
identifying the context information as a location, wherein the location includes one or more of: an origin location of the communication, a physical location of a sender of the communication, and another physical location of an organizer of the communication.

20. The computer-readable memory device of claim 18, wherein the instructions further comprise:
detecting an action on the hashtag displayed with the communication;
identifying one or more other communications categorized with the hashtag;
displaying one or more communication summaries on a summaries user interface, wherein the one or more communication summaries represent the communication and the one or more other communications categorized with the hashtag;
querying an external source with the hashtag to identify one or more external communications categorized with the hashtag; and
presenting, in proximity to the one or more communication summaries, a description of the external source and a link to the external source to access the one or more external communications.
